(19) United States
(12) Patent Application Publication
(10) Pub. No.: US 2009/0092765 A1
(43) Pub. Date: Apr. 9, 2009

(54) MODIFICATION OF ACETALIZED POLYMERS CONTAINING VINYL ALCOHOL GROUPS BY MEANS OF REACTION WITH CARBOXYLIC ACID ANHYDRIDES AND SUBSEQUENT PHOTOCHEMICAL CROSSLINKING

(76) Inventors: Sven Kohnen, Niedernhausen (DE); Michael Frank, Mainz (DE); Robert Fuss, Liederbach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/097,136

(22) PCT Filed: Dec. 6, 2006
(86) PCT No.: PCT/EP06/69395

§ 371 Date: Sep. 26, 2008

(30) Foreign Application Priority Data
Dec. 13, 2005 (EP) 05112011.1

(51) Int. Cl. B05D 3/06; C08G 4/00

(52) U.S. Cl. 427/508; 528/246

(57) ABSTRACT

The invention relates to modified polymers which contain vinyl alcohol groups and are obtained by reacting some of the vinyl alcohol groups with at least one olefinically unsaturated carboxylic acid anhydride and then photochemically crosslinking the reaction product.

The invention relates to the modification of acetalized polymers containing vinyl alcohol groups by means of reaction with at least one carboxylic acid anhydride in the polymer melt and subsequent photochemical crosslinking.

### FIELD OF THE INVENTION

Acetalized polymers containing vinyl alcohol groups, such as polyvinyl butyrals or acetalized ethylene/polyvinyl alcohol copolymers, exhibit, depending upon the degree of acetalization or the residual polyvinyl alcohol content, certain properties, such as for example water insolubility or resistance to mechanical stress. Since the free vinyl alcohol groups of these polymers are still chemically reactive, various attempts were undertaken to change the characteristic of the underlying polymer by means of polymer-analogous reaction at the alcohol functions.

### PRIOR ART

WO 99/23118 describes the preparation of biodegradable polyhydroxy polymers by reacting polyvinyl alcohol with lactones in an extruder.

WO 01/79305 discloses the preparation of high molecular weight, crosslinked polyvinyl butyrals by reacting polyvinyl butyral with at least one di- and/or polycarboxylic acid derivative as crosslinking reagent. A preferred crosslinking reagent is diethyl and/or dimethyl oxalate or the corresponding dicarboxylic acids. The use of carboxylic acid anhydrides is not mentioned in this publication.

The reaction of non-acetalized polyvinyl alcohol or vinyl alcohol copolymers with carboxylic acid anhydrides is disclosed in U.S. Pat. No. 3,548,408. The polyvinyl alcohols described here are saponified to more than 90 mol %, i.e. they have a large number of hydroxy functions. Consequently, by reaction with a carboxylic acid anhydride, high conversions or esterification reactions can be achieved relatively easily.

In JP 08 28 34 28, the reaction of an ethylene/vinyl alcohol copolymer with maleic acid anhydride and subsequent electron beam crosslinking is described. Electron beams have very high energy, so that non-selective, free-radical chain degradation has to be expected in addition to crosslinking here.

Acetalized polyvinyl alcohols, i.e. compounds having a significantly smaller number of free hydroxy functions, are not mentioned in these publications. Furthermore, the photochemical crosslinking of the polymers is not described.

In U.S. Pat. No. 6,326,125, as intermediate for preparing a photosensitive compound, the reaction of acetalized polyvinyl alcohol with a carboxylic acid anhydride is described. However, this intermediate itself is not photosensitive but is reacted in a further reaction with an epoxide containing at least one double bond.

U.S. Pat. No. 4,153,526 discloses UV-crosslinking of polyvinyl acetals in the presence of a photoinitiator. The preceding reaction with maleic acid anhydride is not described here.

In order to crosslink polyvinyl acetals it is also possible to first react them with diesters and subsequently thermally crosslink them. US 2003/0166788 discloses such a reaction process.

Photochemically crosslinkable polyvinyl acetals are also disclosed in U.S. Pat. No. 4,904,0646. Here, crosslinking takes place via additional alcohol functions introduced during acetalization with a hydroxy aldehyde. A reaction with maleic acid anhydride is not described here.

Unmodified polyvinyl acetals have good dispersancy for pigments and are often used as binding agents for printing ink. For this reason, compounds of this kind present themselves as coating materials; however, they do not exhibit sufficient resistance to solvents and only have low mechanical stability.

### OBJECT

It was therefore the object of the present invention to suitably modify polyvinyl acetals for such applications.

### DISCLOSURE OF THE INVENTION

Surprisingly, it was found that acetalized polyvinyl alcohols or acetalized ethylene/vinyl alcohol copolymers can be reacted with carboxylic acid anhydrides and subsequently photochemically crosslinked in a simple manner.

Object of the present invention are therefore modified polymers containing vinyl alcohol groups which are obtainable by partial acetalization of polymers containing vinyl alcohol groups with one or more aldehydes, polymer-analogous reaction of the partially acetalized polymers containing vinyl alcohol groups in the melt with at least one olefinically unsaturated carboxylic acid anhydride and subsequent photochemical crosslinking.

In particular, the crosslinking occurs by crosslinking the side chains newly introduced with the olefinically unsaturated carboxylic acid anhydrides, preferably by photodimerization of the double bonds of these side chains.

Preferably, polyvinyl alcohols and/or ethylene/vinyl acetate/vinyl alcohol copolymers are used as polymer containing vinyl alcohol groups for the acetalization.

These compounds may still contain 0-30% by weight, preferably 0-20% by weight, of vinyl acetate groups, i.e. they may be present fully or partially saponified. The acetalization with one or more aldehydes occurs acid catalyzed in solution, preferably in an aqueous medium under acid catalysis, in a manner known to those skilled in the art. For the acetalization, preferably aliphatic aldehydes having 2 to 10 carbon atoms, in particular butyraldehyde, are used.

According to the invention, the thus obtained polyvinyl acetals that still contain vinyl alcohol groups are reacted with at least one olefinically unsaturated carboxylic acid anhydride, at least a portion of the vinyl alcohol groups reacting in the process.

Prior to the reaction with the carboxylic acid anhydrides, the polymers preferably still contain 10-85 mol %, preferably 15-41 mol %, more preferably 22-35 mol % of free vinyl alcohol groups, the remaining repeating units consisting of vinyl acetate, ethylene and/or vinyl acetal groups.

After reaction with the carboxylic acid anhydrides, the partially acetalized polymers containing vinyl alcohol groups preferably still contain 0.1-84.9 mol %, in particular 0.1-50 mol %, 0.1-40, 0.1-30 or 0.1-20 mol % of vinyl alcohol groups. The content of vinyl alcohol groups is determined as described in the examples.

The reaction with the olefinically unsaturated carboxylic acid anhydrides may take place until all of the hydroxy functions originally contained in the partially acetalized polymer containing vinyl alcohol groups, i.e. in the partially acetalized polyvinyl alcohol or ethylene/polyvinyl alcohol copolymer, have reacted. In order to guarantee sufficient crosslinking later on, at least 5% of the hydroxy functions originally present should react, preferably 5-50%, more preferably 5-25%, most preferably 5-15%.

The reaction of the acetalized polyvinyl alcohols or ethylene/vinyl alcohol copolymers with the carboxylic acid anhydrides probably occurs by esterification of a vinyl alcohol group. If cyclic carboxylic acid anhydrides are used, a free carboxy function is formed in the new side chain. Possibly, and depending upon the reaction conditions, crosslinking reactions involving the free carboxylic acid function of the new side chain and the same or a different polymer chain also occur.

Correspondingly, it is possible that the molecular weight of the partially acetalized polymers increases by means of the reaction with the carboxylic acid anhydrides by 5 to 100%, preferably only slightly, from 10 to 50%. By increasing the temperature of the reaction, the molecular weight can also considerably increase by means of the reaction, e.g. by 50 to 100%.

For the preparation of the products according to the invention, one or more cyclic or acyclic olefinic carboxylic acid anhydrides, such as for example maleic acid anhydride, 1,2,3,6-tetrahydrophthalic acid anhydride, or 3,4,5,6-tetrahydrophthalic acid anhydride, may be used.

In addition, it is possible to perform the reaction in the presence of 1 to 100% by weight, in particular 1 to 30% by weight, (based on the polymer) of plasticizer. In these cases, the melt of a mixture of the acetalized polymers and plasticizers is used for the reaction with the olefinically unsaturated carboxylic acid anhydrides. The presence of small amounts of additives, such as for example UV stabilizers, antioxidants, or acid catalysts, with a total amount between 1 and 25, preferably 5 to 25% by weight, based on the amount of polymer, does not have a negative impact.

A summary of commercial plasticizers which contains information about their compatibility with polyvinyl acetals, in particular polyvinyl butyral, can for example be obtained from the publication Modern Plastics Encyclopedia 1981/1982, pp. 710 to 719. Preferred plasticizers are diesters of aliphatic diols, in particular of aliphatic polyether diols or polyether polyols, with aliphatic carboxylic acids, preferably diesters of polyalkylene oxides, in particular diesters of di-, tri- and tetraethylene glycol with aliphatic (C6-C10)-carboxylic acids, preferably 2-ethylbutyric acid and n-heptanoic acid, also diesters of aliphatic or aromatic (C2-C18)-dicarboxylic acids, preferably adipic, sebacic, and phthalic acid, with aliphatic (C4-C12)-alcohols, preferably dihexyl adipate, phthalates, trimellitates, phosphates, fatty acid esters, in particular triethylene glycol-bis-(2-ethyl butyrate), triethylene glycol ethyl hexanoate (3G8), aromatic carboxylic acid esters, in particular dibenzoates, and/or hydroxycarboxylic acid esters.

The reaction itself is advantageously performed in a suitably heatable kneader, stirred vessel, or extruder. The reaction temperature is preferably between 120° C. and 250° C., in particular between 170° C. and 230° C. The reaction times may be between 30 seconds and 15 minutes; if the reaction is performed in an extruder, reaction times between 30 seconds and 3 minutes are normally sufficient.

Crosslinking of the reaction product of the acetalized polymer and the carboxylic acid anhydride occurs subsequently, probably by crosslinking of two side chains containing a double bond, i.e. by photodimerization with formation of cyclobutane derivatives. This kind of photoinduced crosslinking is known (see for example A. Schönberg, “Preparative Organic Photochemistry”, 2nd compl. rev. ed. 1968, see Scheme A).

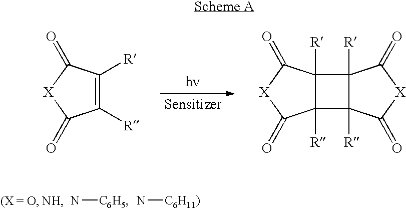

Crosslinking may be performed with UV radiation having a wave length of 100 to 400 nm, i.e. UV radiation of type A, B, and/or C. Exposure times of a few seconds to a maximum of 5 min. have proven useful in practice.

Optionally, the irradiation is performed in the presence of a photosensitizer (triplet sensitizer), such as for example benzophenone, acetophenone, phenanthrene, anthracene, but also ketocoumarines.

The molecular weight of the crosslinked polymers thus obtained may increase by more than 200% compared to the reaction product with carboxylic acid anhydride. Normally, a determination of the molecular weight is no longer possible since the products thus obtained are insoluble in all ordinary solvents.

The photochemical crosslinking of the reaction product of partially acetalized polymer and carboxylic acid anhydride may be performed in the melt or on the solid material, the latter being preferred.

The polymers according to the invention may particularly be used as adhesives and/or coating of plastics or metals (articles such as bottles, table surfaces, floor coverings, etc.).

In particular, the polymers according to the invention may be used for the production of waterproof coatings on paper, polyethylene terephthalate (PET) bottles or other PET-surfaces, polymer films, paints or varnishes, or to improve the surface hardness or as scratch-resistant coatings.

The polymer according to the invention is particularly preferably used as coating or applied to a substrate by preparing the reaction product of the partially acetalized polymers containing vinyl alcohol groups with the carboxylic acid anhydrides, applying it to an article, optionally drying it and subsequently, preferably in the solid state, photochemically crosslinking it. The application of the reaction product to the article is possible in melt, dispersion or solution. To begin with, all organic solvents in which the reaction product is soluble, such as for example alcohols, ketones, esters (e.g. methyl ethyl ketone or acetone), are suitable as solvent, independent of the substrate to be coated.

A further subject matter of the present invention is therefore a method for coating a substrate with modified polymers containing vinyl alcohol groups by
a) partial acetalization of polymers containing vinyl alcohol groups with one or more aldehydes,
b) polymer-analogous reaction of the partially acetalized polymers containing vinyl alcohol groups with at least one olefinically unsaturated carboxylic acid anhydride,
c) applying the reaction product to the substrate, and
d) photochemical crosslinking.

In the present invention, at least a portion of the composition containing polyvinyl acetal, preferably at least 70% by weight, more preferably at least 90% by weight, and most preferably 100% by weight, based on the total weight of the composition transferred into the extruder, can be transferred into an extruder via at least one main metering unit. The main feed is usually at an L/D ratio of up to 5. The L/D ratio is known in the art. Here, L represents the length of the screw and D represents the diameter of the screw. Extruders having similar L/D ratios generally have similar extrusion properties. Specifying the L/D ratio is therefore common, the diameter D of the screw generally being additionally specified. Consequently, the length specification “at an L/D ratio of up to 5” is the result of the multiplication of the specified L/D ratio of 5 with the also known screw diameter D. In case of a screw diameter of 30 mm, the specification “at an L/D ratio of up to 5” means that the main feed is in a section from 0 mm up to a length of 150 mm, based on the starting point of the screw. In case the diameter of the screw is 10 mm, the main feed is in a section from 0 to 50 mm. Since the main feed has an extension over length, it should be noted that these specifications refer to the point of the main feed closest to the starting point.

Side feeding is known in the art, additives usually being added to the melt via this entry into the extruder. Feeding of the anhydride may, among other things, occur via a side feeder that is connected to the extruder and may have at least one conveying screw. Here, the side feeder may have for example one or two conveying screws.

Preferably, the side feeder is cooled, so that no melt forms within this device but the composition containing polyvinyl acetal is introduced into the main extruder for example as powder. Preferably, the temperature in the side feeder is lower than the melting range of the anhydride. Preferably, the temperature in the side feeder is lower than or equal to 100° C., more preferably lower than or equal to 80° C. and most preferably lower than or equal to 50° C.

According to a special aspect, the screw diameter of the side feeder is smaller than the screw diameter of the extruder, the ratio of screw diameter of the extruder to screw diameter of the side feeder preferably being in the range of 1.1:1 to 10:1, more preferably 2:1 to 5:1.

According to a second aspect of the present invention, the section of the extruder from the main feed up to a length of at least 15*L/D, preferably up to a length of at least 20*L/D, can be cooled in order to solve the objects previously set forth. Here, cooling may occur via cooling of the jacket.

The significance of the L/D ratio has previously been explained. In case of a screw diameter of 30 mm, the specification “up to a length of at least 15*L/D” means that the section of the extruder from the main feed up to a length of at least 450 mm is cooled. If the diameter is 10 mm, the section from the main feed up to a length of at least 150 mm is cooled. Since the main feed has an extension over length, it should be noted that these specifications refer to the point of the main feed closest to the starting point.

According to a third aspect of the present invention, at least one of the screws, preferably all of the screws of the extruder can be cooled in order to solve the objects previously set forth. Preferably, the screw is here cooled over a section of the extruder from the main feed up to a length of at least 5*L/D, more preferably at least 10*L/D. Cooling of screws is known in principle in the art.

The rotational speed of the extruder of the main flow and, optionally, of the at least one side feeder may be easily determined and adjusted by those skilled in the art. The rotational speed of the extruder of the main flow is preferably in the range of 50 rpm to 500 rpm, more preferably in the range of 60 rpm to 400 rpm.

According to a special aspect of the present invention, the temperature can be changed here during transformation into the molten state, a temperature increase preferably being carried out in order to for example remove volatile components from the mixture. Here, the temperature can for example be increased step-by-step in order to achieve a gentle and energy-saving removal of these substances. Preferably, the temperature for example during feeding into the extruder is lower than or equal to the glass transition temperature of the acetalized polymer containing vinyl alcohol groups. According to a special aspect, the temperature may be in the range from 40° C. to 120° C., preferably 80° C. to 120° C. Subsequently, this temperature may be increased in the main extruder to a range from 100° C. to 220° C., preferably 130° C. to 220° C., this temperature increase possibly occurring via several steps. Volatile substances and unconverted reactants may be removed from the composition in known manner, for example outgassing. Furthermore, in preferred variations of the method, some zones of the extruder are not needed and may be removed. As a result of this, additional operational advantages result.

The method of “extrusion” or “extrusion molding” refers to a method for producing tubes, wires, profiles, hoses, etc. from thermoplastic materials such as polyvinyl acetal. The extrusion occurs thereby in extruders that are mostly designed as screw extruder, less frequently as ram extruder. They are charged with the thermoplastic material and optionally additional additives via a feed hopper; then the material is heated, homogenized, and pressed through the molding die. Extruders exist in different types; one distinguishes for example between single-screw and multiple-screw extruders depending upon the number of conveying screws. Among the extruders particularly preferred within the scope of the present invention are single-screw and twin-screw extruders, multi-shaft kneaders, kneaders, mills, and calenders.

For further details regarding the above mentioned technical terms it is referred to the standard technical literature, in particular Römpp's Chemielexikon, 5^{th} edition and Saechtling, Kunststofftaschenbuch, 27^{th} edition as well as the references given therein.

It is possible to perform the extrusion with pelletizing of the product. Pelletizing may thereby occur in a manner known in principle, preferably by hot face cutting (in particular by eccentric pelletizing, knife roller pelletizing, water ring pelletizing, or underwater pelletizing) or cold face cutting (in particular strand pelletizing or pelletizing with dicer). These methods are well known in the state of the art.

In hot face cutting, sometimes also referred to as die-face pelletizing, a polymer melt is formed into strands in breaker plates, the strands being cut to the desired grain length immediately upon exiting the breaker plate and cooled. The operation typically takes place in air, an air/water vortex, or under water. In case of a plastic material with little tendency to adhere, cooling may also take place in air, otherwise water is typically used for this. Typically, drying follows afterwards even though it is not absolutely required according to the invention since the polymer normally does not wet.

In cold pelletizing, strands or strips are extruded, cooled in a water bath, and cut into pellets in strand pelletizers or dicers. When pelletizing with dicers, in addition to cross-sectional cutting, the strips also have to be cut in the longitudinal direction.

Measuring Methods

Determination of the Vinyl Alcohol Content

a) Determination of the Acetate Group Content (PV Acetate Content)

The PV acetate content is the percentage of acetyl groups resulting from the consumption of the potassium hydroxide solution necessary for the saponification of 1 g of substance.

Determination Method (On the Basis of EN ISO 3681):

Approximately 2 g of the substance to be analyzed are weighed accurately to 1 mg into a 500 mL round bottom flask and dissolved in 90 mL of ethanol and 10 mL of benzyl alcohol under reflux. After cooling, the solution is neutralized with 0.01 N NaOH against phenolphthalein. Subsequently, 25.0 mL of 0.1 N KOR are added and the solution heated under reflux for 1.5 h. The sealed flask is allowed to cool, and the excess base is back-titrated with 0.1 N hydrochloric acid against phenolphthalein as indicator until the decolorization persists. A blank is treated in the same manner. The PV acetate content is calculated as follows: PV acetate content [%]=(b−a)*86/E, with a=consumption of 0.1 KOH for the sample in mL, b=consumption of 0.1 N KOH for the blank test in mL, and E=dry initial weight of the substance to be examined in g.

b) Determination of the Vinyl Alcohol Group Content (Polyvinyl Alcohol Content) of the Unmodified Polyvinyl Acetal

The polyvinyl alcohol content is the proportion of hydroxyl groups that is detectable by subsequent acetylation with acetic acid anhydride.

Determination Method (On the Basis of DIN 53240)

Approximately 1 g of Mowital is weighed accurately to 1 mg into a 300 mL ground joint Erlenmeyer flask, 10.0 mL of acetic acid anhydride/pyridine mixture (23:77 v/v) is added and the mixture heated to 50° C. for 15-20 hours. After cooling, 17 mL of dichloroethane is added and the mixture is swirled briefly. Subsequently, 8 mL of water is added while stirring, the flask is sealed with a stopper, and the content stirred for 10 minutes. The neck of the flask and the stopper are rinsed with 50 mL of deionized water, covered with a layer of 5 mL n-butanol, and the free acetic acid is titrated with 1 N sodium hydroxide solution against phenolphthalein. A blank is treated in the same manner. The polyvinyl alcohol content is calculated as follows: polyvinyl alcohol content [%]=(b−a)*440/E, with a=consumption of 1 N NaOH for the sample in mL, b=consumption of 0.1 N NaOH for the blank test in mL, and E=dry initial weight of the substance to be examined in g.

For the determination of the vinyl alcohol group content of the polyvinyl acetal reacted with the olefinically unsaturated anhydride, the acetate group content is determined using method a) prior to and after the reaction. By means of the reaction, the acetate group content increases by the number of hydroxy groups that have reacted with the anhydride. The number of hydroxy groups originally present is determined on the original material according to method b). The difference of these values corresponds to the proportion of vinyl alcohol groups in the polyvinyl acetal reacted with the olefinically unsaturated anhydride.

### EXAMPLES

Reaction of the Polymers Containing Partially Acetalized Vinyl Alcohol with the Olefinically Unsaturated Anhydride

In a twin-screw extruder from Leistritz Company having a screw diameter of 30 mm and a L/D ratio of 44, Mowital BG 30 H (vinyl alcohol content 27.7 mol %) from Kuraray Specialities Europe GmbH was extruded with a speed of 15 kg/h. The pellets were introduced into the extruder via the main feed, the temperature being 50° C. in the feeding section, 180° C. in the melting zone, and 170° C. in the die. 10% (based on the mixture) of maleic acid anhydride was also metered into the main feed via a second gravimetric solids feeder. The strand obtained was pelletized, pellets having a bulk density of 650 g/L being obtained. In this test, a screw configuration having a high mixing action and low shearing action was chosen. The arrangement of the different mixing and conveying elements to adjust the mixing and shearing action is known to those skilled in the art. The vinyl alcohol content of the polymer thus obtained is 22.3 mol %.

Crosslinking Reaction

a) Preparing the Solution:

10 g of the modified BG 30 H from the aforementioned reaction is added to 90 g of ethanol and dissolved while stirring. Subsequently, 0.4 g of benzophenone as photosensitizer is added and stirred again until a clear solution results.

b) Coating/Crosslinking:

Subsequently, the solution is applied to a PET backing film with a wet film thickness of 200 μm. Application of the solution may take place by means of standard coating techniques such as for example knife coating, spray coating, flow coating, dipping, printing, etc. After drying of the coating (at 40° C.), curing in an UV oven (UV-A cube, Hönle Company) with a medium pressure mercury lamp (nominal output 100 W/cm) takes place for 120 seconds.

The molecular weight of the products obtained was subsequently determined using gel permeation chromatography. The molecular weight of the original polymer (Mowital BG 30 H) was Mw=34200, the molecular weight of the product reacted with maleic acid anhydride was Mw=37900. The system crosslinked with UV radiation was insoluble in all common solvents, so that a molecular weight could not be determined.

c) Testing:

The UV-crosslinked coating is tested for its resistance to solvents using the Solvent Rub Test and resistance to abrasion using the Taber Abrader Test. As Comparative Example, in both tests the non-UV-exposed material is used.

C1a) Solvent Rub Test:

A cotton swab or a cotton ball is saturated with acetone (or another solvent) and rubbed back and forth over the surface of the coating. The number of rubs until the coating is rubbed through is determined. The larger the number of rubs, the better is the resistance to the solvent used. The following Table 1 shows the results:

TABLE 1

| | Ex. 1 - not UV | Ex. 2 UV exposed/ |
|---|---|---|
| | exposed | crosslinked |
| Number of rubs - MEK | <5 | >25 |
| Number of rubs - ethanol | <5 | >40 |

c2) Taber Abrader Test:

On the basis of DIN 52347 or ASTM D1044, the sample is examined using a slide/roll abrasion method. Two friction rollers are pressed onto the surface of the sample. The sample rotates and initiates a slipping relative motion of the friction rollers. An approximately linear contact zone is formed between the friction rollers and the sample. The contact pressure may be varied from 2.5 to 10 N by different weights. The abrasion is given as mass loss at a given number of revolutions.

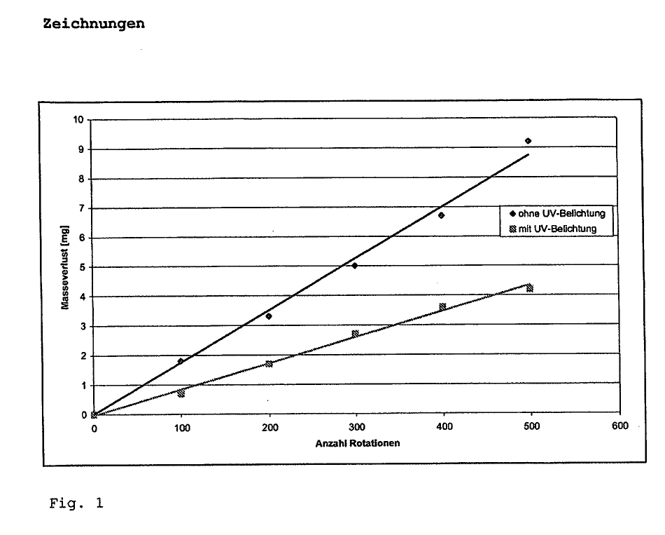

For the tests, the respective coating was applied to an aluminum test plate in 3 separate coating steps, dried, and UV exposed (120 sec., medium pressure Hg, 100 W/cm). The coating to be tested had a layer thickness of about 40 μm. As testing apparatus, the Taber Abraser 5130 (Taber Industries) and the friction rollers “Calibrase CS17” were used. The suction output was set at 70%, the weight loading (contact pressure) was 500 g. The following Table 2 and FIG. 1 show the results:

TABLE 2

| | Ex. 1 - not UV | Ex. 2 - UV exposed/ |
|---|---|---|
| Number of | exposed | crosslinked |
| revolutions | mass loss [mg] | mass loss [mg] |
| 100 | 1.5 | 0.7 |
| 200 | 2.7 | 1.7 |
| 300 | 4.4 | 2.9 |
| 400 | 6.7 | 3.6 |
| 500 | 9.2 | 4.2 |

It becomes apparent that the polymers made according to the invention have significantly improved solvent resistances and abrasion resistance.

1. A modified polymer containing vinyl alcohol groups which is obtainable by partial acetalization of a polymer containing vinyl alcohol with one or more aldehydes, polymer-analogous reaction of the polymer containing partially acetalized vinyl alcohol in the melt with at least one olefinically unsaturated carboxylic acid anhydride and subsequent photochemical crosslinking.

2. A modified polymer containing vinyl alcohol groups according to claim 1, wherein the polymer containing vinyl alcohol is a polyvinyl alcohol or an ethylene/vinyl alcohol copolymer.

3. A modified polymer containing vinyl alcohol groups according to claim 1, wherein UV radiation having a wavelength of 100 to 400 nm is used for said photochemical crosslinking.

4. A modified polymer containing vinyl alcohol groups according to claim 1, wherein photochemical crosslinking is performed in the presence of a photosensitizer.

5. A modified polymer containing vinyl alcohol groups according to claim 1, wherein the partially acetalized polymer containing vinyl alcohol groups contain 0.1-84.9 mol % of vinyl alcohol groups after reaction with the carboxylic acid anhydrides.

6. A modified polymer containing vinyl alcohol groups according to claim 1, wherein the molecular weight of the partially acetalized polymers containing vinyl alcohol groups increases by means of the reaction with the carboxylic acid anhydrides by 5 to 100%.

7. A modified polymer containing vinyl alcohol groups according to claim 1, wherein the molecular weight of the partially acetalized polymers containing vinyl alcohol groups increases by means of the reaction with the carboxylic acid anhydrides and subsequent crosslinking by more than 200%.

8. A modified polymer containing vinyl alcohol groups according to claim 1, wherein photochemical crosslinking is performed in the solid state.

9. A modified polymer containing vinyl alcohol groups according to claim 1, wherein the reaction of the partially acetalized polymer containing vinyl alcohol groups with the carboxylic acid anhydride is performed in an extruder, kneader or stirred vessel.

10. A coated substrate comprising a plastic or metal substrate and a coating of a modified containing vinyl alcohol groups according to claim 1 applied to said substrate any of claims 1 to 9 as adhesive and/or coating.

11. A method for coating a substrate with modified polymers containing vinyl alcohol groups by
a) partial acetalization of polymers containing vinyl alcohol with one or more aldehydes,
b) polymer-analogous reaction of the polymers containing partially acetalized vinyl alcohol with at least one olefinically unsaturated carboxylic acid anhydride,
c) applying the resultant reaction product to the substrate, and
d) photochemical crosslinking the resultant reaction product.
